(19) United States
(12) Patent Application Publication
(10) Pub. No.: US 2013/0131885 A1
(43) Pub. Date: May 23, 2013

(54) SYSTEM AND METHOD FOR OBTAINING AND MANAGING TEMPERATURE DATA

(71) Applicants: CHENG-YEN HUANG, Tu-Cheng (TW); SHENG-WEI SU, Tu-Cheng (TW)

(72) Inventors: CHENG-YEN HUANG, Tu-Cheng (TW); SHENG-WEI SU, Tu-Cheng (TW)

(73) Assignee: HON HAI PRECISION INDUSTRY CO., LTD., Tu-Cheng (TW)

(21) Appl. No.: 13/332,477

(22) Filed: Dec. 21, 2011

(30) Foreign Application Priority Data
Nov. 17, 2011 (TW) 100141966

(51) Int. Cl. G05D 23/19; G06F 15/16

(52) U.S. Cl. 700/300; 709/204

(57) ABSTRACT

A fan control system for controlling the rotation speed of a number of fans includes motherboards corresponding to the fans, a network switch connected to the motherboards, a dynamic host configuration protocol (DHCP) server connected to the network switch, and a fan control board (FCB). The FCB gets port IDs and Internet Protocol (IP) addresses corresponding to the motherboards by reading a Media Access Control (MAC) address table from the network switch and an IP address table from the DHCP server, thereby reading the motherboard temperature from BMCs mounted on the motherboards to control the rotation speed of the fans.

### BACKGROUND

1. Technical Field

The present disclosure relates to a system and a method of getting temperature data.

2. Description of Related Art

In many electronic devices and systems managing environmental temperatures and component temperatures can be very important. For example, in server systems, one or more fans controlled by a fan control board (FCB) are mounted in each server for motherboard heat dissipation. In general, a baseboard management controller (BMC) mounted on a motherboard provides that motherboard's temperature through an intelligent platform management interface (IPMI) in real time to the FCB, and the FCB can control the rotation speed of the corresponding fans accordingly. However, the FCB needs to be connected to the motherboard through a special connector and a special cable, which adds to the cost of the server.

### BRIEF DESCRIPTION OF THE DRAWING

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of an exemplary embodiment of a temperature data management system applied in a fan control system.

FIG. 2 is a flow chart of an exemplary method for getting remote sensor temperature data.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

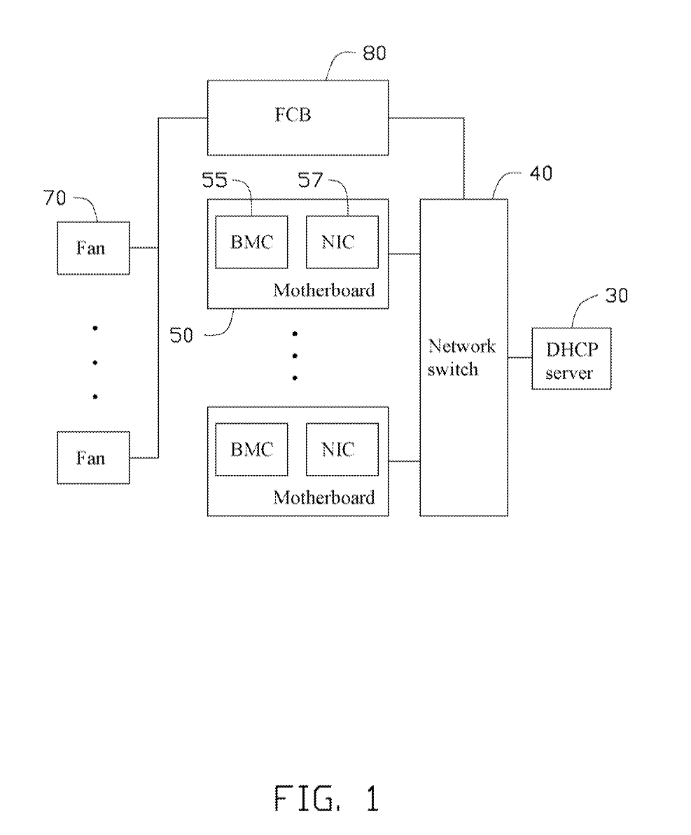

Referring to the FIG. 1, a fan control system is configured for controlling the rotation speed of one or more fans 70 in a data center (not shown) according to obtained temperature data. An exemplary embodiment of the fan control system includes motherboards 50 corresponding to the fans 70, a network switch 40 connected to the motherboards 50, a dynamic host configuration protocol (DHCP) server 30 connected to the network switch 40, and a fan control board (FCB) 80 connected between each of the fans 70 and the network switch 40.

For each of the motherboards 50 there is a corresponding fan 70 to provide heat dissipation. Each of the motherboards 50 includes a network interface card (NIC) 57 with a unique Media Access Control (MAC) address, and a baseboard management controller (BMC) 55 for providing the motherboard temperature.

The network switch 40 comprises a MAC address table (not shown). The MAC address table comprises a plurality of MAC addresses, and port identifications (IDs) corresponding to the NICs 57. Each of the port IDs corresponds to a unique one of the MAC addresses in the MAC address table, and the MAC address corresponding to the port IDs is consistent with the MAC address in the corresponding NIC 57. In this embodiment, the network switch 40 is a layer-2 ethernet switch.

The DHCP server 30 includes an assigned Internet Protocol (IP) address table (not shown). The IP address table includes a plurality of IP addresses assigned to the motherboards 50, and a plurality of MAC addresses corresponding to the IP addresses. The MAC addresses in the IP address table are consistent with the MAC addresses in the MAC address table.

The FCB 80 communicates with the network switch 40 through a port such as a registered jack (RJ-45) port. The FCB 80 reads the MAC address table from the network switch 40 using Address Resolution Protocol (APR), and reads the IP address table from the DHCP server 30 through Transmission Control Protocol/Internet Protocol (TCP/IP), thereby getting the port IDs and IP addresses corresponding to the motherboards 50. The FCB 80 gets the motherboard temperatures by sending an intelligent platform management interface (IPMI) over local area network (LAN) (IOL) command to the BMCs 55 through the network switch 40, thereby getting the temperatures of the motherboards 50 based on the corresponding port IDs and MAC addresses and then controlling the rotation speeds of the fans 70 to provide more or less airflow as needed.

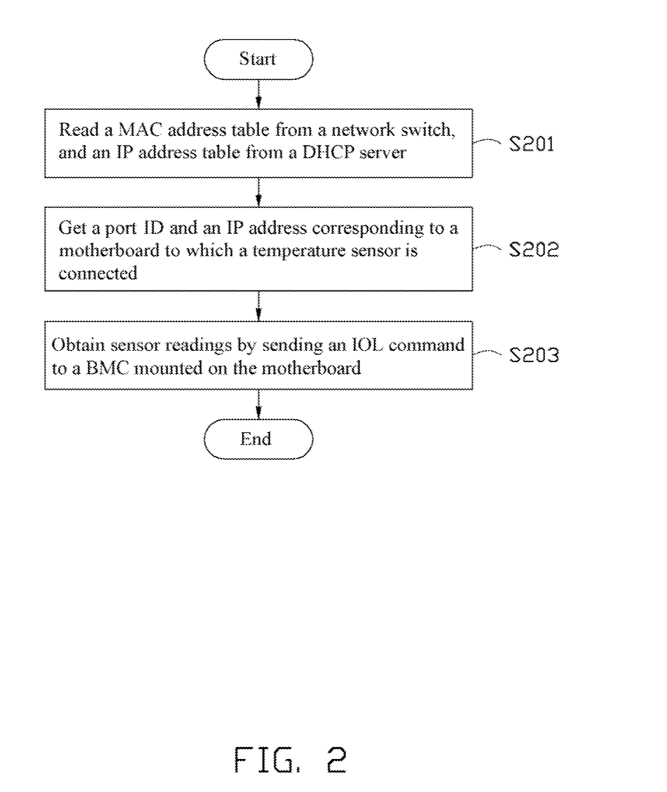

Referring to the FIG. 2, an exemplary method for obtaining temperature data of the motherboards 50 includes the following steps:

In step 5201, the FCB 80 reads the MAC address table from the network switch 40 using ARP, and the assigned IP address table from the DHCP server 30 through the TCP/IP.

In step 5202, the FCB 80 gets the port ID and the IP address corresponding to one of the motherboards 50 based on the read MAC address table and IP address table.

In step 5203, the FCB 80 obtains sensor readings by sending the IOL command to the corresponding BMC 55 through the net work switch 40, thereby getting the temperature data of the motherboard 50 based on the corresponding port ID and the MAC address.

The foregoing description of the exemplary embodiments of the disclosure has been presented only for the purposes of illustration and description and is not intended to be exhaustive or to limit the disclosure to the precise forms disclosed. Many modifications and variations are possible. The embodiments were chosen and described in order to explain the principles of the disclosure and their practical application so as to enable others of ordinary skill in the art to utilize the disclosure and various embodiments and with such various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than by the foregoing description and the exemplary embodiments described therein.

What is claimed is:

1. A fan control system for controlling the rotation speed of a plurality of fans, comprising:
a plurality of motherboards, for each of the motherboards there is a corresponding fan to provide heat dissipation, each of the motherboards comprising a network interface card (NIC) with a unique Media Access Control (MAC) address, and a baseboard management controller (BMC) for providing motherboard temperature in real time;
a network switch connected to the motherboards, and comprising a MAC address table with a plurality of MAC addresses and port identifications (IDs), wherein each of the port IDs corresponds to a unique one of the MAC addresses in the MAC address table, the MAC address corresponding to the port ID is consistent with the MAC address in the corresponding NIC;
a dynamic host configuration protocol (DHCP) server connected to the network switch, and comprising an assigned Internet Protocol (IP) address table with a plurality of IP addresses and MAC addresses, wherein each of the IP addresses is corresponding to one of the MAC addresses in the IP address table, the MAC addresses in the IP address table are consistent with the MAC addresses in the MAC address table; and
a fan control board (FCB) connected between each of the fans and the network switch, wherein the FCB gets the port IDs and the IP addresses corresponding to the motherboards by reading the MAC address table from the network switch and the IP address table from the DHCP server, thereby reading the motherboard temperature from the BMCs through the network switch to control the rotation speed of the fans.

2. The fan control system of claim 1, wherein the network switch is a layer-2 Ethernet switch.

3. The fan control system of claim 1, wherein the FCB gets the motherboard temperature by sending an intelligent platform management interface (IPMI) over local area network (LAN) (IOL) command to the BMCs using Transmission Control Protocol/Internet (Protocol TCP/IP) standard.

4. A method for getting remote sensor temperature data, comprising:
reading a Media Access Control (MAC) address table from a network switch using Address Resolution Protocol (APR), and an assigned Internet Protocol (IP) address table from a dynamic host configuration protocol (DHCP) server through Transmission Control Protocol/Internet Protocol (TCP/IP);
getting a port ID and an IP address corresponding to a motherboard to which the sensor is connected based on the read MAC address table and IP address table; and
obtaining sensor readings by sending an intelligent platform management interface (IPMI) over local area network (LAN) (IOL) command to a baseboard management controller (BMC) mounted on the motherboard through the network switch.
